(19) United States
(12) Patent Application Publication
(10) Pub. No.: US 2007/0227283 A1
(43) Pub. Date: Oct. 4, 2007

(54) PARKING LOCK MECHANISM FOR AUTOMATIC TRANSMISSION

(75) Inventors: Yasushi FUJIMOTO, Wako-shi (JP); Katsuhiko ITO, Wako-shi (JP); Toshiyuki SATO, Wako-shi (JP); Kinya MIZUNO, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/690,997

(22) Filed: Mar. 26, 2007

(30) Foreign Application Priority Data
Mar. 31, 2006 (JP) 2006-100251

(51) Int. Cl. F16H 59/00

(52) U.S. Cl. 74/337.5

(57) ABSTRACT

An automatic transmission includes primary drive gears that are fixed on main-shaft sleeve provided on a main shaft; primary driven gears which are rotatably provided on a countershaft, which constantly mesh with the primary drive gears, and which are selectively connected to the countershaft. Further, a first clutch engages and disengages power between the main shaft and the main-shaft sleeve; and secondary drive gears are rotatably provided on the main shaft, and are selectively connected to the main shaft. Secondary driven gears which are fixed on a countershaft sleeve provided on the countershaft, and which constantly mesh with the secondary drive gears. A second clutch engages and disengages power between the countershaft and the countershaft sleeve. A parking lock position is established when clutches are disengaged and one forward gear and a reverse gear are concurrently connected to the countershaft.

### BACKGROUND OF THE INVENTION

The present invention relates to a parking lock mechanism for automatic transmissions for vehicles.

Various conventional parking lock mechanisms for automatic transmissions have been disclosed (for example, see Japanese Patent Application Laid-Open No. 2003-106453 (FIG. 5 to FIG. 8). An example of such mechanisms includes such members as an internal ring gear—the output member of the automatic transmission—with engaging teeth formed on its outer periphery, a parking pole meshing with the teeth of the internal ring gear, a parking shaft supporting the parking pole, a parking rod, a support actuator, and the like.

### SUMMARY OF THE INVENTION

A problem that the conventional systems have is that since such a system requires especially dedicated members and a series of members to actuate these dedicated members, has a large dimension and a heavy weight, and is produced only at a high cost. Accordingly, an object of the present invention is to provide a parking lock mechanism requiring no member especially dedicated for the parking-lock purpose, while the parking lock mechanism is light weight and compact in size, and, moreover, reliable in its operation.

The present invention solves the above-mentioned problem. The invention relates to a parking lock mechanism for an automatic transmission with the following characteristics. The parking lock mechanism for an automatic transmission includes a main shaft and a countershaft. Additionally, the parking lock mechanism for an automatic transmission includes primary drive gears that are fixed on a main-shaft sleeve provided rotatably and coaxially on the main shaft; primary driven gears which are rotatably provided on the countershaft, which constantly mesh with the primary drive gears, and which are selectively connected to the countershaft; and a first clutch that engages and disengages power between the main shaft and the main-shaft sleeve. Moreover, the parking lock mechanism for an automatic transmission includes secondary drive gears which are rotatably provided on the main shaft, and which are selectively connected to the main shaft; secondary driven gears which are fixed on a countershaft sleeve provided rotatably and coaxially on the countershaft, and which constantly mesh with the second drive gears; and a second clutch that engages and disengages power between the countershaft and the countershaft sleeve. Furthermore, the parking lock mechanism for an automatic transmission includes a reverse drive gear fixed on the main-shaft sleeve; and a reverse driven gear which is rotatably provided on the countershaft, which constantly meshes with an intermediate gear meshing constantly with the reverse drive gear, and which is selectively connected to the countershaft. In such a parking lock mechanism, the above-mentioned two clutches are made neutral, and then one of the forwarding driven gears fixed on the countershaft as well as the reverse driven gear fixed on the countershaft are concurrently connected to the countershaft.

The invention described above may also include additional characteristics. For example, a means for connecting concurrently the two gears at the time of parking lock may include a shift drum driven by an electric motor. The means may also include a cam groove programmed in advance and drilled (or formed) in the shift drum, and a shifter that slides in an axial direction in response to being driven by movement of the cam groove. Furthermore, the means includes means which slides in an axial direction by being driven by the shifter, and which engages and disengages the gears that are rotatable relative to the main shaft and the countershaft.

According to the invention described herein, a parking lock mechanism that is light weight, compact in size and reliable in its operation can be provided. In addition, such a parking lock mechanism is provided without adding an especially dedicated member, but by modifying members conventionally used.

Further, according to the instant invention, a parking lock can be done by a simple operation.

### BRIEF DESCRIPTION OF THE DRAWINGS

FIG. 1 is an expanded schematic diagram showing the configuration of a power unit 1A according to a first embodiment of the present invention, with each of rotating shafts thereof being included;

FIG. 2 is a schematic diagram describing the operation at the time when the vehicle starts in the first-speed gear;

FIG. 3 is a schematic diagram describing the operation at the time when the gear is shifted from the first-speed gear to the second-speed gear;

FIG. 4 is a schematic diagram describing the operation at the time when the gear is shifted from the second-speed gear to the third-speed gear;

FIG. 5 is a schematic diagram describing the operation at the time when the gear is shifted from the third-speed gear to the fourth-speed gear;

FIG. 6 is a schematic diagram describing the operation at the time when the gear is in the reverse gear;

FIG. 7 is a schematic diagram describing the parking-lock operation; and

FIG. 8 is a diagram for describing a power unit 1B according to a second embodiment, with a transmission of the power unit 1B in the second embodiment being described side by side with a transmission of the power unit 1A in the first embodiment.

### DETAILED DESCRIPTION OF THE INVENTION

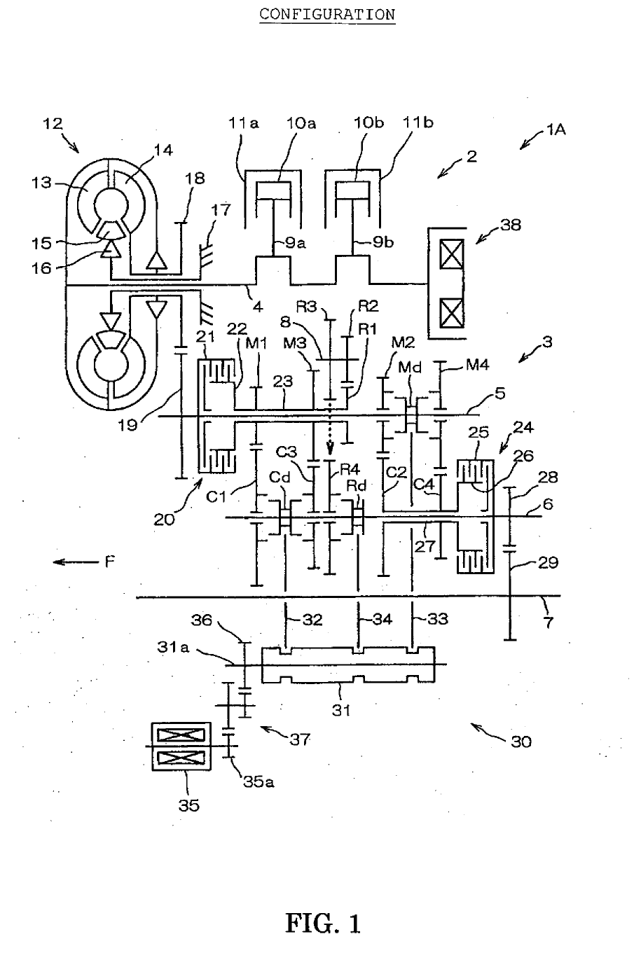

FIG. 1 is an expanded schematic diagram showing the configuration of a power unit 1A according to a first embodiment of the present invention, with each of rotating shafts thereof being included. The power unit 1A shown in FIG. 1 is, for example, mounted on a buggy-type vehicle. Note that the left direction (arrow F) in the figure indicates the front of the vehicle. An internal combustion engine 2 and a transmission 3 are integrated into this power unit 1A, and the power unit 1A includes a crankshaft 4, a main shaft 5 of the transmission 3, a countershaft 6 of the transmission 3, an output shaft 7, and a reverse-shifting intermediate shaft 8. All of these shafts are placed in parallel to one another along the front to rear directions of the vehicle. These rotating shafts are rotatably supported by a crankcase member 17 positioned at both front and rear sides of the shafts. Power is transmitted from the crankshaft 4 to the output shaft 7, via a transmission process. In this embodiment, the internal combustion engine 2 is a two-cylinder internal combustion engine. Connecting rods 9a and 9b connect pistons 10a and 10b to the crankshaft 4. The pistons 10a and 10b reciprocally travel in the cylinder 11a and 11b, respectively. Thus, the above-mentioned power is generated.

On the crankshaft 4, at the rear end thereof, an AC generator 38 is attached, in order to generate electricity. Mean while, a torque converter 12 is attached on the crankshaft 4, but at the front end thereof The torque converter 12 is constituted by a pump impeller 13 fixed on the crank shaft 4, a turbine runner 14 located as being opposed to the pump impeller 13 and rotating freely, a stator 15 held by the crankcase member 17 with a one-way clutch 16. A primary drive gear 18, rotatable relatively to the crankshaft 4, is connected to the turbine runner 14, also rotatable relatively to the crankshaft 4. The power generated in the internal combustion engine 2 is transmitted from the crankshaft 4 to the pump impeller 13, and then to the turbine runner 14 via the operating fluid. In this way, the primary drive gear 18 is driven.

A primary driven gear 19 is fixed on the main shaft 5 of the transmission 3 at the front end thereof, while the primary driven gear 19 constantly meshes with the primary drive gear 18. The rotation of the crankshaft 4 is transmitted to the main shaft 5 of the transmission 3, as being subjected to the primary reduction by the primary drive gear 18 and the primary driven gear 19.

A first hydraulic multi-plate clutch 20 is provided as being adjacent to the above-mentioned primary driven gear 19 in the front-end portion of the main shaft 5. The above-mentioned multi-plate clutch 20 has a clutch outer 21 fixed on the main shaft 5, and has a clutch inner 22. A main-shaft sleeve 23 is connected to the clutch inner 22. The main-shaft sleeve 23 covers the outside of the frontal half of the main shaft 5, and is rotatable relative to the main shaft 5. The main-shaft sleeve 23, as configured above, can rotate together with the clutch inner 22. On the main-shaft sleeve 23, a first-speed drive gear M1, a third-speed drive gear M3 and a reverse drive gear R1 are fixed in this order from the front.

The main shaft 5 extends penetrating the center of the first hydraulic multi-plate clutch 20 and passing through the central hole of the main-shaft sleeve 23. On the main shaft 5, in the rear portion thereof, a second-speed drive gear M2 and a fourth-speed drive gear M4 are supported as being rotatable relative to the main shaft 5. A dog clutch Md is provided between the two gears, as being splined to fit onto the main shaft 5 and thus being movable in the front-to-rear directions.

The reverse switching intermediate shaft 8 is rotatably supported, as extending in parallel to the above-mentioned main shaft 5. A first reverse intermediate gear R2 and a second reverse intermediate gear R3 are provided on the reverse switching intermediate shaft 8. The first reverse intermediate gear R2 constantly meshes with the above-mentioned reverse drive gear R1. The second reverse intermediate gear 13 rotates in conjunction with the first reverse intermediate gear R2 via the reverse switching intermediate shaft 8.

The countershaft 6 is rotatably supported, as extending in parallel to the above-mentioned main shaft 5. On the countershaft 6, at the frontal half thereof, a first-speed driven gear C1 and a third-speed driven gear C3 are rotatably supported, while the first-speed and the third-speed driven gears C1 and C3 constantly mesh respectively with the first-speed and the third-speed drive gears M1 and M3 mentioned above. A dog clutch Cd is provided between the above two gears C1 and C3, as being splined to fit onto the countershaft 6 and being movable in the front-to-rear directions. A reverse driven gear R4 is rotatably supported on the countershaft 6 as being adjacent to and behind these gears C1 and C3, while the reverse driven gear R4 constantly meshes with the above-mentioned second reverse intermediate gear R3. Furthermore, a dog clutch Rd is provided behind the reverse driven gear R4 as being splined to fit onto the countershaft 6 and being movable in the front-to-rear directions.

A second hydraulic multi-plate clutch 24 is provided in the rear-end portion of the countershaft 6. The above-mentioned multi-plate clutch 24 has a clutch outer 25 fixed on the countershaft 6, and has a clutch inner 26. A countershaft sleeve 27 is connected to the clutch inner 26. The countershaft sleeve 27 covers the outside of the rear half of the countershaft 6, and is rotatable relative to the countershaft 6. The countershaft sleeve 27, as configured above, can rotate together with the clutch inner 26. On the countershaft sleeve 27, a second-speed driven gear C2, which constantly meshes with the above-mentioned second-speed drive gear M2, and a fourth-speed driven gear C4, which constantly meshes with the above-mentioned fourth-speed drive gear M4, are fixed in this order from the front. A countershaft output gear 28 is fixed on the countershaft 6 at the rear-most end thereof.

An output-shaft driven gear 29 is fixed on the output shaft 7, which is provided as being in parallel to the above-mentioned countershaft 6, while the output-shaft driven gear 29 constantly meshes with the countershaft output gear 28. The output of the power unit 1A is transmitted from the front end of the output shaft 7 to the front wheels as well as from the rear end of the output shaft 7 to the rear wheels.

A gear-shift mechanism 30 is provided near the main shaft 5 and the countershaft 6. This gear-shift mechanism 30 is constituted by a shift drum 31, a first, a second and a third shifters 32, 33 and 34, and a driving apparatus. The shift drum 31, extending in parallel to the main shaft 5 and the countershaft 6, is supported as being capable of moving rotationally. The three shifters 32, 33 and 34, are driven in the front-to-rear directions along three cam-grooves formed in the outer circumference of the shift drum 31. The driving apparatus includes an electric motor 35 and the like, which drive to rotate the shift drum 31. A gear 36 is provided on the shaft 31a of the shift drum 31. Reduction gears 37 are provided, a first one of which the gear 36 meshes with, and a second one of which meshes with an output pinion 35a of the above-mentioned electric motor 35. The above-mentioned electric motor 35 makes the shift drum move rotationally to take an appropriate position, which makes the three shifters 32, 33 and 34, move selectively. The above-mentioned first shifter 32 engages with the dog clutch Cd, the second shifter 33 engages with the dog clutch Md, and the third shifter 34 engages with the dog clutch Rd. The shifters 32, 33 and 34 move respective dog clutches Cd, Md and Rd in front-to-rear directions. The electric motor 35 is operated with a switch provided to the steering handle.

In the above-mentioned transmission 3, the dog clutch Cd can be placed at a first-speed side position where the dog clutch Cd engages with the first-speed driven gear C1, and at a third-speed side position where the dog clutch Cd engages with the third-speed driven gear C3. The dog clutch Cd can also be placed at a neutral position, that is, an intermediate position between the above-mentioned two positions. In addition, the dog clutch Md can be placed at a second-speed side position where the dog clutch Md engages with the second-speed drive gear M2, and at a fourth-speed side position where the dog clutch Md engages with the fourth-speed drive gear M4. The dog clutch Md can also be placed at a neutral position, that is, an intermediate position between the above-mentioned two positions. Meanwhile, the dog clutch Rd can be placed at a reverse side position where the dog clutch Rd engages with the reverse driven gear R4, and at a neutral position where the dog clutch Rd disengages with the reverse driven gear R4.

The forwarding first-speed to the fourth-speed gears and the reverse gear are selectively connected to the respective shafts in the following way. The above-mentioned dog clutches Cd, Md and Rd are moved by the three shifters 32, 33 and 34 in the front-to-rear direction, and thus the dog clutches Cd, Md and Rd are selectively made to be connected to the gears provided as being capable of rotating relatively to the respective shafts. The positions of shifters are defined by the cam grooves programmed in advance and drilled in the shift drum 31. The above-mentioned electric motor 35 controls the rotational motion of the shift drum 31. The positions of the first shifter 32 are: the first-speed side position at the front; the third-speed side position at the rear; and the neutral position in between. The positions of the second shifter 33 are: the second-speed side position at the front; the fourth-speed side position at the rear; and the neutral position in between. The positions of the third shifter 34 are: the reverse side position at the front; and the neutral position at the rear. In every step of operation, an unillustrated hydraulic system is used to actuate and switch the hydraulic multi-plate clutches 20 and 24.

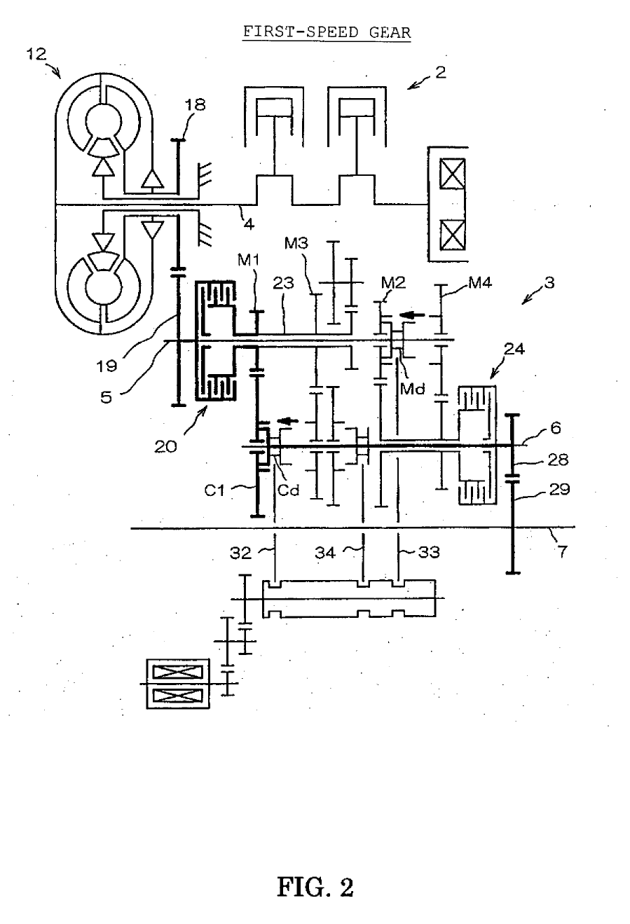

FIG. 2 to FIG. 6 are diagrams for describing operation of the above-mentioned transmission 3 at the time when the vehicle runs just as usual. The power generated in the internal combustion engine 2 is transmitted, via the crankshaft 4 and then the torque converter 12, to the primary drive gear 18. The power transmission route up to here is the same irrespective of the current gear-shifting state. In each of the above-mentioned diagrams for describing operation, the power transmission route, corresponding to each of the gear-shifting states, from the primary drive gear 18 to the output-shaft driven gear 29 is shown by thick lines.

FIG. 2 is a diagram describing the operation at the time when the vehicle starts in the first-speed gear. At this time, the first shifter 32 is moved to the first-speed side to make the dog clutch Cd engage with the first-speed driven gear C1, and the second shifter 33 is moved to the second-speed side to make the dog clutch Md engage with the second-speed drive gear M2. Meanwhile, the third shifter 34 is kept at the neutral position. Note that the third shifter 34 is always kept at the neutral position when the vehicle is running forward. Connecting the first multi-plate clutch 20 in the above-mentioned state makes the vehicle start in the first-speed gear. The power from the primary drive gear 18 is transmitted to the output shaft 7, via the primary driven gear 19, the main shaft 5, the first multi-plate clutch 20, the main-shaft sleeve 23, the first-speed drive gear M1, the first-speed driven gear C1, the countershaft 6, the countershaft output gear 28, and the output-shaft driven gear 29. Then, the power thus transmitted is outputted to the wheels. Here, the second-speed drive gear M2 is fixed on the shaft with the dog clutch Md, but the second multi-plate clutch 24 is not connected. As a result, the power is not transmitted to the countershaft 6.

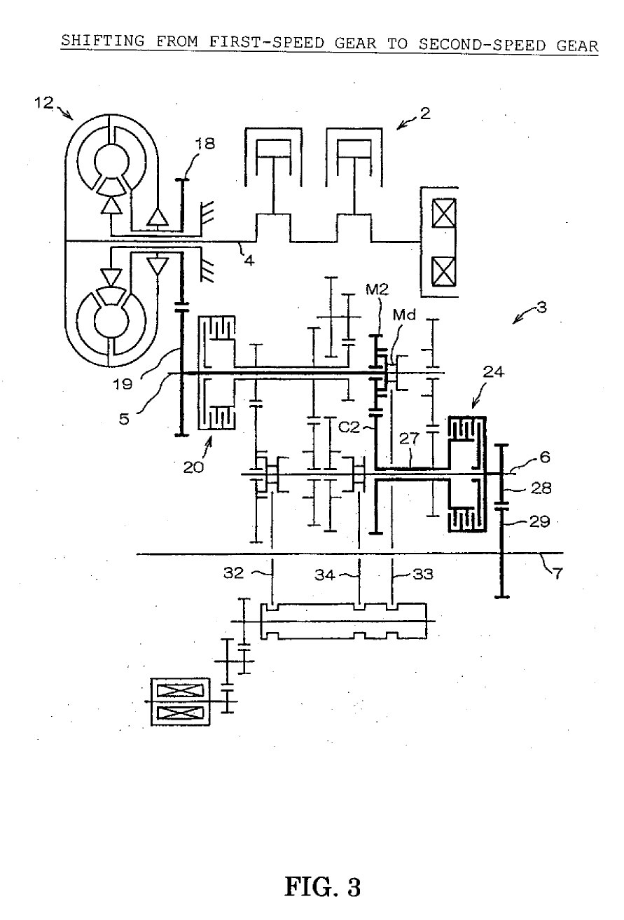

FIG. 3 is a diagram describing the operation at the time when the gear is shifted from the first-speed gear to the second-speed gear. The positions of the shifters stay at the same positions where they are in the first-speed gear as shown in FIG. 2. In this state, the application of the hydraulic pressure to the first multi-plate clutch 20, is stopped. Now, the application of the hydraulic pressure is switched to the second multi-plate clutch 24. This switching shifts the gear from the first-speed gear to the second-speed gear. The power from the primary drive gear 18 is transmitted to the output shaft 7, via the primary driven gear 19, the main shaft 5, the dog clutch Md, the second-speed drive gear M2, the second-speed driven gear C2, the countershaft sleeve 27, the second multi-plate clutch 24, the countershaft 6, the countershaft output gear 28, and the output-shaft driven gear 29.

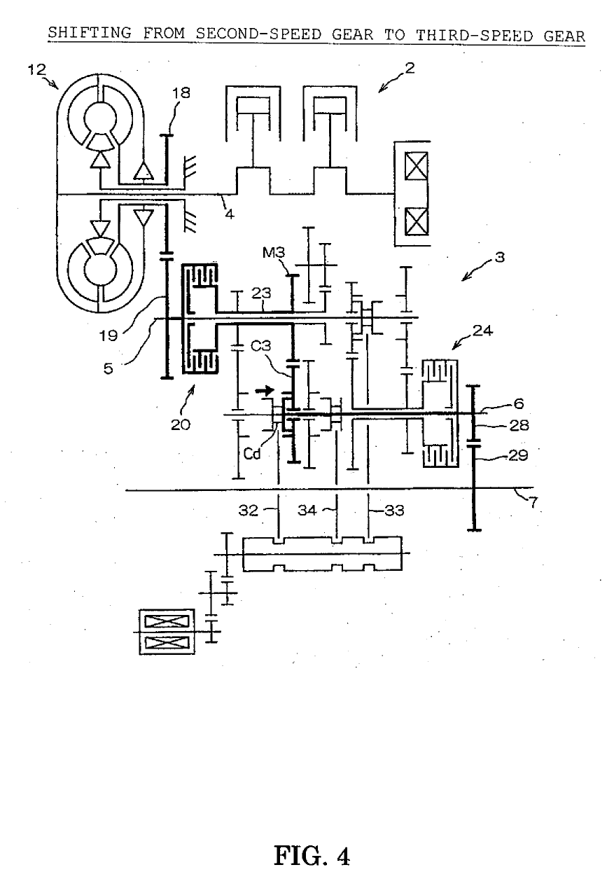

FIG. 4 is a diagram describing the operation at the time when the gear is shifted from the second-speed gear to the third-speed gear. While the vehicle is cruising in the second-speed gear, the first shifter 32 is moved to move the dog clutch Cd from the first-speed side to the third-speed side to make the dog clutch Cd engage with the third-speed driven gear C3, as a preparation for shifting to the third-speed gear. In this state, the application of the hydraulic pressure to the second multi-plate clutch 24 is stopped. Now, the application of the hydraulic pressure is switched to the first multi-plate clutch 20. This switching shifts the gear from the second-speed gear to the third-speed gear. The power from the primary drive gear 18 is transmitted to the output shaft 7, via the primary driven gear 19, the main shaft 5, the first multi-plate clutch 20, the main-shaft sleeve 23, the third-speed drive gear M3, the third-speed driven gear C3, the dog clutch Cd, the countershaft 6, the countershaft output gear 28, and the output-shaft driven gear 29.

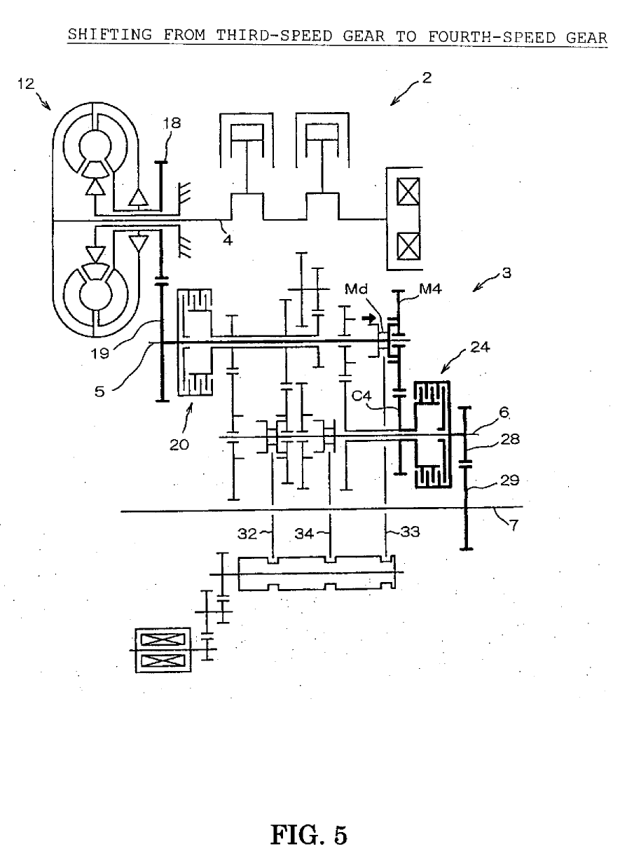

FIG. 5 is a diagram describing the operation at the time when the gear is shifted from the third-speed gear to the fourth-speed gear. While the vehicle is cruising in the third-speed gear, the second shifter 33 is moved to move the dog clutch Md from the second-speed side to the fourth-speed side to make the dog clutch Md engage with the fourth-speed drive gear M4, as a preparation for shifting to the fourth-speed gear. In this state, the application of the hydraulic pressure to the first multi-plate clutch 20 is stopped. Now, the application of the hydraulic pressure is switched to the second multi-plate clutch 24. This switching shifts the gear from the third-speed gear to the fourth-speed gear. The power from the primary drive gear 18 is transmitted to the output shaft 7, via the primary driven gear 19, the main shaft 5, the dog clutch Md, the fourth-speed drive gear M4, the fourth-speed driven gear C4, the second multi-plate clutch 24, the countershaft 6, the countershaft output gear 28, and the output-shaft driven gear 29.

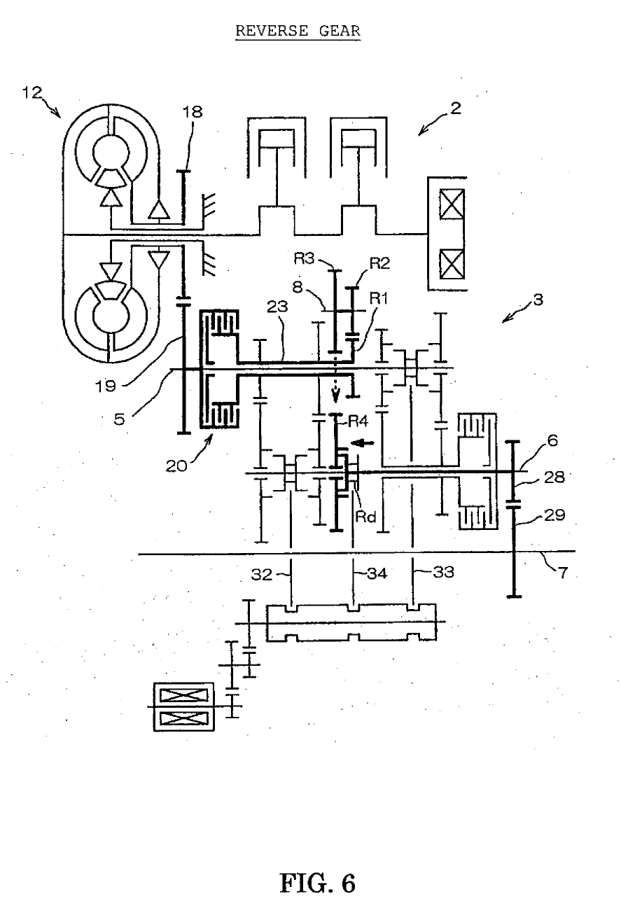

FIG. 6 is a diagram describing the operation at the time when the gear is in the reverse gear. While the first and the second shifters 32 and 33 are kept neutral, the third shifter 34 is moved to the reverse side to make the dog clutch Rd engage with the reverse driven gear R4. Connecting the first multi-plate clutch 20 in this state makes the vehicle run backwards. The power from the primary drive gear 18 is transmitted to the output shaft 7, via the primary driven gear 19, the main shaft 5, the first multi-plate clutch 20, the main-shaft sleeve 23, the reverse drive gear R1, the first intermediate gear R2, the second intermediate gear R3, the reverse driven gear R4, the dog clutch Rd, the countershaft 6, the countershaft output gear 28, and the output-shaft driven gear 29. Now that the first and the intermediate gears R2 and R3 are intervened, the countershaft 6 and the output shaft 7, and the like rotate in the reverse direction, and the wheels are driven for backward motion.

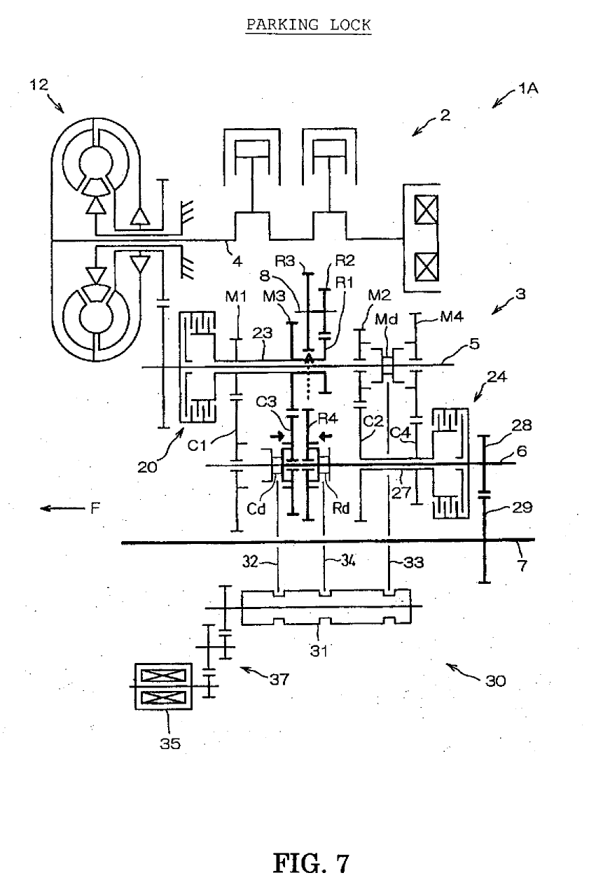

FIG. 7 is a diagram describing the parking-lock operation according to the present invention. The parking lock is the blocking of the transmission of the rotation, which the wheels applies to the output shaft 7, from the output shaft 7 to the internal combustion engine 2, in a state where the internal combustion engine 2 is switched off to make the output zero, or is idling.

The parking-lock operation is carried out as follows. To begin with, the application of the hydraulic pressure to the multi-plate clutches 20 and 24, respectively at the front and at the rear is stopped, so that each of the two clutches 20 and 24 are in a neutral state. Then, the first and the third shifters 32 and 34 are moved to move, respectively, the dog clutches Cd and Rd. Thus, both of the third-speed driven gear C3 and the reverse driven gear R4 are connected to the countershaft 6. In this state, when the torque from the wheels is applied to the above-mentioned driven gears C3 and R4 via the output shaft 7 and the countershaft 6, this torque is transmitted to the third-speed drive gear M3 and the reverse drive gear R1, both of which are fixed to the main-shaft sleeve 23. Here, the torque of the gear M3 acting on the main-shaft sleeve 23 has a rotating direction opposite to the rotating direction of the torque of the gear R1 acting on the main-shaft sleeve 23, so that none of the main-shaft sleeve 23 and gears M3, R1, C3 and R4 is allowed to rotate. Accordingly, neither the output shaft 7, connected to the countershaft 6 via the gears 28 and 29, nor the wheels linked to the output shaft 7 can move. The parking lock is done in this way.

Shown in the embodiment thus far described is an example in which the third-speed driven gear C3 and the reverse driven gear R4 engage respectively with the dog clutches Cd and Rd. A similar effect can be achieved by replacing the third-speed driven gear C3 with the first-speed driven gear C1 fixed to the countershaft 6, and then making the first-speed driven gear C1 and the reverse driven gear R4 engage respectively with the dog clutches Cd and Rd. Generally, parking lock can be done by making both of the two multi-plate clutches be neutral, and then connecting one of the forwarding driven gears and the reverse driven gear, both of which are fixed on the countershaft, to the countershaft concurrently.

The positions of dog clutches that are made to engage concurrently are defined by the cam grooves programmed in advance and drilled in the shift drum 31. The shift drum 31 is moved rotationally by controlling the electric motor 35. The electric motor 35 is controlled so that the position of the rotational motion of the shift drum 31 may be placed at a position corresponding to P among the selector buttons set up to have such positions as 4, 3, 2, 1, N, R, and P when the parking lock is done.

Generic names are given to gear groups, except for the reverse gears, in the above-mentioned configuration of the automatic transmission. Gears fixed on the main-shaft sleeve 23, to which the first clutch 20 continues or discontinues the power from the main shaft 5, are named the primary drive gears. Meanwhile gears, provided on the countershaft 6, constantly meshing with the above-mentioned primary drive gears, and selectively connected to the countershaft 6, are named the primary driven gears. These two gear groups are named generically the primary gears. In addition, gears provided on the main shaft 5, and selectively connected to the main shaft 5 are named the secondary drive gears. Meanwhile gears fixed on the countershaft sleeve 27, to which the second clutch 24 continues or discontinues the power from the countershaft 6, and constantly meshing with the above mentioned secondary drive gears, are named the secondary driven gears. These two gear groups are named generically the secondary gears.

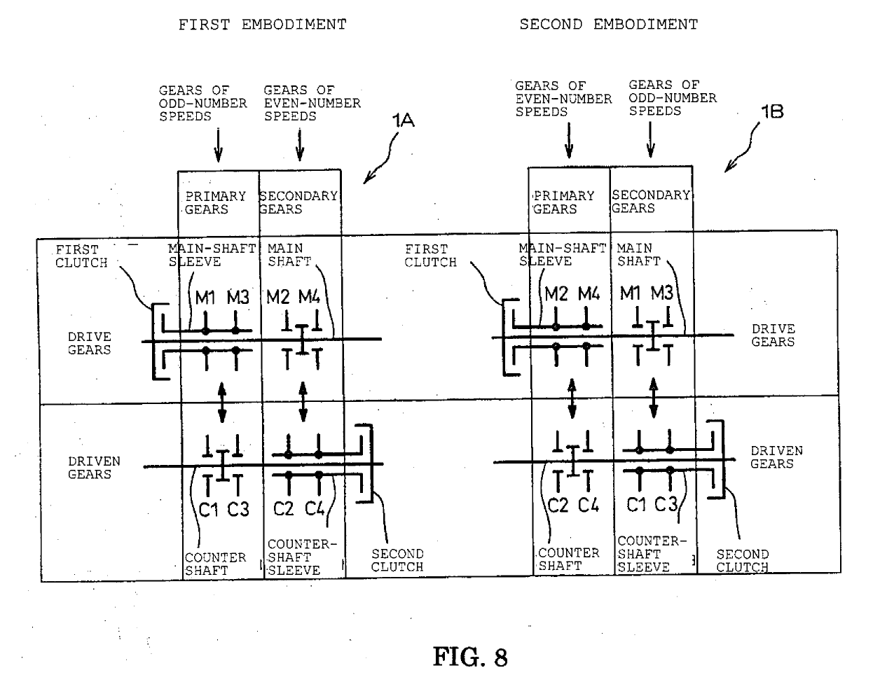

FIG. 8 is a diagram for describing a power unit 1B according to a second embodiment. In FIG. 2, a transmission of the power unit 1B in the second embodiment is described side by side with the transmission of the power unit 1A in the first embodiment. The crankshafts, the torque converters, the output shafts are omitted in the illustration of FIG. 8. In the above-described first embodiment, the primary gears consist of the gears of the odd-number speeds (the first-speed gears and the third-speed gears), and the secondary gears consist of the gears of the even-number speeds (the second-speed gears and the fourth-speed gears). In the second embodiment of the present invention, however, the alignment of the odd-number-speed gears and the even-number-speed gears is reversed to make the primary gears consist of the gears of the even-number speeds (the second-speed gears and the fourth-speed gears), and the secondary gears consist of the gears of the odd-number speeds (the first-speed gears and the third-speed gears). In other words, the transmission in the second embodiment is configured by arranging the second-speed gears and the fourth-speed gears as the primary gears, and by arranging the first-speed gears and the third-speed gears as the secondary gears. In FIG. 8, reference numerals for the gears in the second embodiment are the same as those for the gears that have the same functions in the first embodiment. In addition, the placement of the reverse gears relative to the shafts in the second embodiment is the same as that in the first embodiment.

Also in the above-mentioned configuration of the power unit 1B in the second embodiment, parking lock can be done by making both of the two multi-plate clutches be neutral, and then connecting one of the forwarding driven gears and the reverse driven gear, both of which are fixed on the countershaft, to the countershaft concurrently.

The transmission in each of the above-mentioned embodiments is a four-speed automatic transmission, but the transmission may be of five or more speeds with an increased number of gears. Also in such a case, parking lock can be done by making both of the two multi-plate clutches be neutral, and then connecting one of the forward driven gears and the reverse driven gear, both of which are fixed on the countershaft, to the countershaft concurrently.

As described thus far, the following effects are obtained in these embodiments. Firstly, a parking lock mechanism is provided that is light weight and compact in size, and, moreover, is reliable in its operation. In addition, such a parking lock mechanism is provided without adding an especially dedicated member, but by modifying members conventionally used. Secondly, parking lock can be done by a simple operation.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. A parking lock mechanism for an automatic transmission, comprising:
a main shaft having a main shaft sleeve rotatable and coaxial with respect thereto;
a countershaft substantially parallel to said main shaft, and having a countershaft sleeve rotatable and coaxial with respect to said countershaft;
primary drive gears fixed on said main-shaft sleeve;
primary driven gears rotatably provided on said countershaft, which constantly mesh with corresponding primary drive gears, and which are selectively connected to said countershaft;
a first clutch that engages and disengages power between said main shaft and said main-shaft sleeve;
secondary drive gears rotatably provided on said main shaft, and which are selectively connected to said main shaft;
secondary driven gears fixed on said countershaft sleeve, and which constantly mesh with corresponding secondary drive gears;
a second clutch that engages and disengages power between said countershaft and said countershaft sleeve;
a reverse drive gear fixed on said main-shaft sleeve; and
a reverse driven gear rotatably provided on said countershaft, which constantly meshes with an intermediate gear meshing constantly with said reverse drive gear, and which is selectively connected to said countershaft,
wherein, in a parking lock position, said first and second clutches are in a neutral position, and one of said forward driven gears fixed on said countershaft, as well as said reverse driven gear fixed on said countershaft are concurrently connected to said countershaft.

2. The parking lock mechanism for an automatic transmission as recited in claim 1, further comprising:
a shift drum driven by an electric motor;
a cam groove programmed in advance and formed in said shift drum;
a shifter slideable in an axial direction in response to movement of said cam groove; and
engaging means, slideable in an axial direction in response to movement of said shifter, for engaging and disengaging said gears that are rotatable relatively to said main shaft and said countershaft,
wherein, in said parking lock position, said one forward driven gear on said countershaft and said reverse driven gear on said countershaft are concurrently connected to said countershaft in response to movement of said shift drum.
